(19) United States
(12) Patent Application Publication
(10) Pub. No.: US 2024/0072376 A1
(43) Pub. Date: Feb. 29, 2024

(54) BATTERY AND METHOD FOR MANUFACTURING BATTERY

(71) Applicant: Panasonic Intellectual Property Management Co., Ltd., Osaka (JP)

(72) Inventors: Kazuyoshi HONDA, Osaka (JP); Koichi HIRANO, Osaka (JP); Akira KAWASE, Osaka (JP); Kazuhiro MORIOKA, Osaka (JP)

(21) Appl. No.: 18/503,997

(22) Filed: Nov. 7, 2023

Related U.S. Application Data
(63) Continuation of application No. PCT/JP2022/013181, filed on Mar. 22, 2022.

(30) Foreign Application Priority Data
May 13, 2021 (JP) 2021-081927

(51) Int. Cl. H01M 50/46; H01M 10/058

(52) U.S. Cl. CPC H01M 50/46; H01M 10/058

(57) ABSTRACT

A battery includes battery cells. A battery cell includes a positive electrode active material layer, a negative electrode active material layer, and a solid electrolyte layer disposed between the positive electrode active material layer and the negative electrode active material layer. On a side surface of the battery cell, in a plan view of the side surface of the battery cell, striated cut marks which are inclined with respect to the thickness direction of the battery cell are provided.

### CROSS REFERENCE TO RELATED APPLICATIONS

This is a continuation application of PCT International Application No. PCT/JP2022/013181 filed on Mar. 22, 2022, designating the United States of America, which is based on and claims priority of Japanese Patent Application No. 2021-081927 filed on May 13, 2021. The entire disclosures of the above-identified applications, including the specifications, drawings and claims are incorporated herein by reference in their entirety.

### FIELD

The present disclosure relates to a battery and a method for manufacturing a battery.

### BACKGROUND

In the manufacture of batteries, the ends of battery cells or components of battery cells may be cut in order to determine the shape of the battery, remove unnecessary portions, and the like.

Patent Literature (PTL) 1 discloses that the temporarily cut surface of the current collector is subjected to insulation treatment.

PTL 2 discloses that an external electrode of a current collector is provided on the side surface of a unit stack of a plurality of electrostrictive effect elements connected with an adhesive, and then the plurality of electrostrictive effect elements are interconnected.

### CITATION LIST

### Patent Literature

PTL 1: Japanese Unexamined Patent Application Publication No. 2008-53103
PTL 2: Japanese Unexamined Patent Application Publication No. H4-167579

### SUMMARY

### Technical Problem

In prior art, it is desired to further suppress short circuits in batteries using solid electrolytes and improve reliability such as quality stability.

Unlike liquid-based batteries, batteries using solid electrolytes have no separator, so it is important to suppress the deterioration of reliability caused by cut surfaces.

Therefore, the present disclosure provides a highly reliable battery and a method for manufacturing the battery.

### Solution to Problem

A battery in one aspect of the present disclosure includes at least one battery cell, wherein the at least one battery cell includes a positive electrode layer, a negative electrode layer, and a solid electrolyte layer disposed between the positive electrode layer and the negative electrode layer, and in a plan view of a side surface of the at least one battery cell, the side surface of the at least one battery cell is provided with striated recesses or striated protrusions that are inclined with respect to a thickness direction of the at least one battery cell.

In addition, a method for manufacturing a battery according to one aspect of the present disclosure is a method for manufacturing a battery including a battery cell including a positive electrode layer, a negative electrode layer, and a solid electrolyte layer disposed between the positive electrode layer and the negative electrode layer, the method including: cutting the battery cell with a cutting blade, wherein in the cutting, the battery cell is cut down by the cutting blade while at least one of the battery cell or the cutting blade is slid in a length direction of the cutting blade.

### Advantageous Effects

According to the present disclosure, it is possible to provide a highly reliable battery and a method for manufacturing the battery.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic side view showing a schematic configuration of a battery according to Embodiment 1.

FIG. 2 is a schematic side view showing a schematic configuration of a battery according to Comparative example.

FIG. 3A is a schematic front view showing an example of a cutting device used for cutting a battery cell according to Embodiment 1.

FIG. 3B is a schematic side view showing an example of a cutting device used for cutting a battery cell according to Embodiment 1.

FIG. 3C is a diagram for explaining an example of the movement of the cutting device.

FIG. 4 is a diagram for explaining another example of the movement of the cutting device.

FIG. 5 is a schematic side view showing a schematic configuration of a battery according to a variation of Embodiment 1.

FIG. 6 is a schematic side view showing a schematic configuration of a battery according to Embodiment 2.

FIG. 7 is a schematic side view showing a schematic configuration of another battery according to Embodiment 2.

FIG. 8 is a schematic side view showing a schematic configuration of still another battery according to Embodiment 2.

### DESCRIPTION OF EMBODIMENTS

### (Underlying Knowledge Leading to One Aspect of the Present Disclosure)

As mentioned above, in the manufacture of batteries, there are cases where the ends of battery cells are cut in order to determine the shape of the battery, remove unnecessary parts, and the like. A cut surface formed by cutting the battery cell along the thickness direction of the battery cell is a side surface of the battery cell. At this time, for example, if a battery cell including a positive electrode active material layer, a solid electrolyte layer, and a negative electrode active material layer between a positive electrode current collector and a negative electrode current collector is collectively cut, a plurality of striated cut marks extending from the positive electrode current collector to the negative electrode current collector, which are substantially parallel to each other, are generated on the cut surface.

One of the typical causes of short-circuiting of the positive and negative electrodes in batteries containing solid electrolytes is dielectric breakdown due to edge surface discharge along the side surface of the battery cell. Since the striated cut marks generated by collective cutting are recesses or protrusions provided on the side surface, the electric field tends to concentrate on the striated cut marks. The place where the electric field concentrates in this way tends to be the start and end of the edge surface discharge. For that reason, among the striated cut marks, the portion provided on the positive electrode current collector or the positive electrode active material layer and the portion provided on the negative electrode current collector or the negative electrode active material layer become the start and end of the edge surface discharge, and edge surface discharge is likely to occur along the striated cut marks. Therefore, the shorter the length of the striated cut marks between the positive electrode current collector or positive electrode active material layer and the negative electrode current collector or negative electrode active material layer, the greater the risk of edge surface discharge.

The present disclosure has been made based on such findings, and provided are a battery and a method for manufacturing a battery that can improve reliability by suppressing edge surface discharge caused by striated recesses or protrusions such as striated cut marks provided on the side surface of a battery cell.

### (Summary of the Present Disclosure)

A summary of one aspect of the present disclosure is as follows.

A battery in one aspect of the present disclosure includes: at least one battery cell, wherein the at least one battery cell includes a positive electrode layer, a negative electrode layer, and a solid electrolyte layer disposed between the positive electrode layer and the negative electrode layer, and in a plan view of a side surface of the at least one battery cell, the side surface of the at least one battery cell is provided with striated recesses or striated protrusions that are inclined with respect to a thickness direction of the at least one battery cell.

As mentioned above, the electric field tends to concentrate on the striated recesses or the striated protrusions provided on the side surface of the battery cell, and the striated recesses or the striated protrusions tend to be the start and end of the edge surface discharge on the side surface. In the present aspect, in a plan view of the side surface of the battery cell, the striated recesses or the striated protrusions are inclined with respect to the thickness direction of the battery cell, so that the striated recesses or the striated protrusions between the negative electrode layer and the positive electrode layer become longer than when they are not inclined. That is, the distance between the portion provided in the negative electrode layer and the portion provided in the positive electrode layer in the striated recesses or the striated protrusions where the electric field tends to concentrate is increased. Therefore, by suppressing the occurrence of edge surface discharge on the side surface of the battery cell, the occurrence of a short circuit due to dielectric breakdown can be suppressed, and a highly reliable battery can be realized.

In addition, for example, in a plan view of the side surface of the at least one battery cell, an angle formed between the striated recess or the striated protrusion and the thickness direction may be at least 18 degrees and at most 84 degrees.

Accordingly, in a plan view of a side surface of the battery cell, compared to the case where the striated recesses or the striated protrusions are not inclined with respect to the thickness direction of the battery cell, the striated recesses or the striated protrusions between the negative electrode layer and the positive electrode layer are 5% or more longer, and the battery reliability can be improved. In addition, for example, when striated recesses or the striated protrusions are formed by cutting down while sliding the cutting blade or the battery cell in a direction perpendicular to the thickness direction of the battery cell, the slide stroke of the cutting blade or the battery cell is ten times or less the minimum stroke of the cutting blade or the battery cell required for cutting the battery cell. For that reason, the equipment for cutting battery cells can be made compact.

In addition, for example, in a plan view of the side surface of the at least one battery cell, an angle formed between the striated recess or the striated protrusion and the thickness direction may be at least 25 degrees and at most 78 degrees.

Accordingly, in a plan view of a side surface of the battery cell, compared to the case where the striated recesses or the striated protrusions are not inclined with respect to the thickness direction of the battery cell, the striated recesses or the striated protrusions between the negative electrode layer and the positive electrode layer are 10% or more longer, and the battery reliability can be further improved. In addition, for example, when striated recesses or the striated protrusions are formed by cutting down while sliding the cutting blade or the battery cell in a direction perpendicular to the thickness direction of the battery cell, the slide stroke of the cutting blade or the battery cell is five times or less the minimum stroke of the cutting blade or the battery cell required for cutting the battery cell. For that reason, the equipment for cutting battery cells can be made more compact.

In addition, for example, when in a plan view of a side surface of the at least one battery cell, the striated recesses or the striated protrusions may be curved.

This makes it possible to lengthen the striated recesses or the striated protrusions between the negative electrode layer and the positive electrode layer, thereby further improving the reliability of the battery.

In addition, for example, a depth of the striated recesses or a height of the striated protrusions may be 0.1 μm or more.

Since the striated recesses or the striated protrusions are larger than a predetermined size, even if the electric field is likely to concentrate on the striated recesses or the striated protrusions, in a plan view of the side surface of the battery cell, the striated recesses or the striated protrusions are inclined with respect to the thickness direction of the battery cell, so that the reliability of the battery can be improved.

In addition, for example, the at least one battery cell may include a plurality of battery cells, and the plurality of battery cells may be stacked.

Accordingly, even in a stacked battery in which battery cells are stacked, the reliability of the battery can be improved.

In addition, for example, striated recesses or striated protrusions in adjacent battery cells among the plurality of battery cells may be continuous.

The striated recesses or striated protrusions like this can be formed by collectively cutting a plurality of battery cells in a stacked manner, so that the battery manufacturing process can be simplified.

In addition, for example, in a plan view of side surfaces of adjacent battery cells among the plurality of battery cells, a direction of inclination of the striated recesses or the striated protrusions in one of the adjacent battery cells may be opposite a direction of inclination of the striated recesses or the striated protrusions in an other of the adjacent battery cells with respect to the thickness direction.

Accordingly, even if the battery is subjected to an impact or the like, damage to the battery originating from the striated concave or striated protrusion is less likely to propagate, and the reliability of the battery can be improved.

In addition, a method for manufacturing a battery according to one aspect of the present disclosure is a method for manufacturing a battery including a battery cell including a positive electrode layer, a negative electrode layer, and a solid electrolyte layer disposed between the positive electrode layer and the negative electrode layer, the method including: cutting the battery cell with a cutting blade, wherein in the cutting, the battery cell is cut down by the cutting blade while at least one of the battery cell or the cutting blade is slid in a length direction of the cutting blade.

As such, in the cutting step, at least one of the battery cell or the cutting blade slides in the length direction of the cutting blade, so that the trajectory of the cutting blade on the cutting plane is inclined from the thickness direction of the battery cell. As a result, even if the cut marks of the striated recesses or striated protrusions by the cutting blade are formed on the cut surface, the cut marks are inclined with respect to the thickness direction of the battery cell in a plan view of the cut surface of the battery cell. For that reason, in a plan view of the side surface of the battery cell, the cut marks between the negative electrode layer and the positive electrode layer are longer than when they are not inclined with respect to the thickness direction of the battery cell. Therefore, by suppressing the occurrence of edge surface discharge at the cut surface of the battery cell, the occurrence of a short circuit due to dielectric breakdown can be suppressed, and a highly reliable battery can be manufactured. Furthermore, cutting resistance can be reduced because the battery cell is cut not only by cutting the battery cell with the cutting blade, but also by sliding the blade edge of the cutting blade. Accordingly, since the stress applied to the battery cell during cutting is reduced, the risk of damage such as microcracks occurring inside the battery cell near the cut surface due to the stress can be reduced, so that a highly reliable battery can be manufactured.

Hereinafter, embodiments of the present disclosure will be described with reference to the drawings.

It should be noted that the embodiments described below are all comprehensive or specific examples. Numerical values, shapes, materials, components, arrangement positions and connection forms of components, steps, order of steps, and the like shown in the following embodiments are examples, and are not intended to limit the present disclosure. In addition, among the components in the following embodiments, components not described in independent claims will be described as optional components.

In addition, each figure is a schematic diagram and is not necessarily exactly illustrated. Therefore, for example, scales and the like do not necessarily match in each figure. In addition, in each figure, substantially the same configurations are denoted by the same reference numerals, and overlapping descriptions are omitted or simplified.

In addition, in the present specification, terms that indicate the relationship between elements such as parallel, terms that indicate the shape of elements such as rectangles, and numerical ranges are not expressions that express only strict meanings, but are expressions that include a difference in substantially equivalent ranges, for example, about a difference of about several percent difference.

### Embodiment 1

### [Configuration]

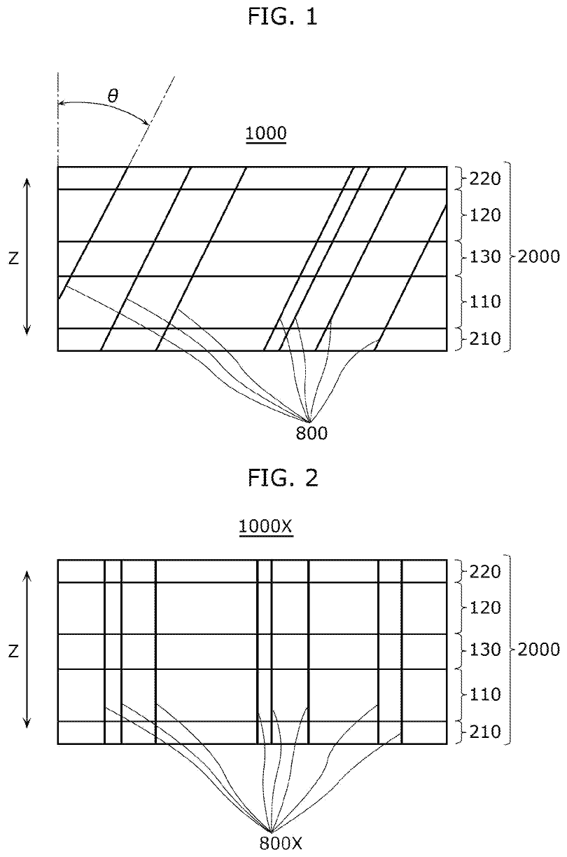

First, the configuration of the battery in Embodiment 1 will be described. FIG. 1 is a schematic side view showing a schematic configuration of battery 1000 according to Embodiment 1. FIG. 1 is a diagram in a plan view of a side surface connecting two main surfaces of battery 1000. In addition, FIG. 1 is also a diagram in a plan view of a side surface of battery cell 2000 provided in battery 1000. A plan view of a side surface can also be said to be a view of battery 1000 or battery cell 2000 along the normal direction of the side surface of battery 1000 or battery cell 2000.

As shown in FIG. 1, battery 1000 according to Embodiment 1 includes at least one battery cell 2000. Battery cell 2000 has, for example, a rectangular parallelepiped shape, but may have another shape. Although battery 1000 includes one battery cell 2000, battery 1000 may include a plurality of battery cells. A battery including a plurality of battery cells will be described later. Battery cell 2000 includes negative electrode current collector 210, negative electrode active material layer 110, solid electrolyte layer 130, positive electrode active material layer 120, and positive electrode current collector 220. In the present disclosure, negative electrode active material layer 110 is an example of a negative electrode layer, and positive electrode active material layer 120 is an example of a positive electrode layer.

Negative electrode current collector 210, negative electrode active material layer 110, solid electrolyte layer 130, positive electrode active material layer 120, and positive electrode current collector 220 are stacked in this order. It should be noted that battery cell 2000 is only needed to include at least negative electrode active material layer 110, solid electrolyte layer 130, and positive electrode active material layer 120. For example, battery cell 2000 may not include at least one of negative electrode current collector 210 or positive electrode current collector 220.

Negative electrode active material layer 110 and positive electrode active material layer 120 face each other with solid electrolyte layer 130 interposed therebetween. Negative electrode active material layer 110 is located between negative electrode current collector 210 and solid electrolyte layer 130. Positive electrode active material layer 120 is located between positive electrode current collector 220 and solid electrolyte layer 130.

Negative electrode active material layer 110 is a layer containing a negative electrode material. The negative electrode material used for negative electrode active material layer 110 includes, for example, a negative electrode active material. Negative electrode active material layer 110 is arranged to face positive electrode active material layer 120.

As the negative electrode active material contained in negative electrode active material layer 110, various materials capable of withdrawing and inserting ions such as lithium (Li) or magnesium (Mg) can be used. As a material for the negative electrode active material, for example, a negative electrode active material such as graphite or metallic lithium can be used.

In addition, the negative electrode material used for negative electrode active material layer 110 may further contain, for example, a solid electrolyte such as an inorganic solid electrolyte. As the inorganic solid electrolyte, for example, a sulfide solid electrolyte or an oxide solid electrolyte can be used. As a sulfide solid electrolyte, for example, a mixture of lithium sulfide (Li₂S) and phosphorus pentasulfide (P₂S₅) can be used. In addition, the negative electrode material used for negative electrode active material layer 110 may further contain, for example, a conductive material such as acetylene black. In addition, the negative electrode material used for negative electrode active material layer 110 may further contain a binding binder such as polyvinylidene fluoride.

Negative electrode active material layer 110 can be produced by applying a paste-like paint in which the negative electrode material used for negative electrode active material layer 110 is kneaded together with a solvent onto the surface of negative electrode current collector 210 and drying it. In order to increase the density of negative electrode active material layer 110, the negative electrode plate including negative electrode active material layer 110 and negative electrode current collector 210 may be pressed after drying. The thickness of negative electrode active material layer 110 is, for example, at least 5 μm and at most 300 μm, but is not limited thereto.

Positive electrode active material layer 120 is a layer containing a positive electrode material. The positive electrode material is the material that constitutes the counter electrode of the negative electrode material. The positive electrode material used for positive electrode active material layer 120 includes, for example, a positive electrode active material.

As the positive electrode active material contained in positive electrode active material layer 120, various materials capable of withdrawing and inserting ions such as Li or Mg can be used. As a material for the positive electrode active material, for example, a positive electrode active material such as lithium cobaltate composite oxide (LCO), lithium nickelate composite oxide (LNO), lithium nnanganate composite oxide (LMO), lithium-manganese-nickel composite oxide (LMNO), lithium-manganese-cobalt composite oxide (LMCO), lithium-nickel-cobalt composite oxide (LNCO), and lithium-nickel-manganese-cobalt composite oxide (LNMCO) can be used.

In addition, the positive electrode material used for positive electrode active material layer 120 may further contain, for example, a solid electrolyte such as an inorganic solid electrolyte. As the solid electrolyte, the materials exemplified as the solid electrolyte contained in the negative electrode material mentioned above can be used. In addition, the surface of the positive electrode active material may be coated with a solid electrolyte. In addition, the positive electrode material used for positive electrode active material layer 120 may further contain, for example, a conductive material such as acetylene black. In addition, the positive electrode material used for positive electrode active material layer 120 may further contain, for example, a binding binder such as polyvinylidene fluoride.

Positive electrode active material layer 120 can be produced by applying a paste-like paint in which the positive electrode material used for positive electrode active material layer 120 is kneaded together with a solvent onto the surface of positive electrode current collector 220 and drying it. In order to increase the density of positive electrode active material layer 120, the positive electrode plate including positive electrode active material layer 120 and positive electrode current collector 220 may be pressed after drying. The thickness of positive electrode active material layer 120 is, for example, at least 5 μm and at most 300 μm, but is not limited thereto.

Solid electrolyte layer 130 is arranged between negative electrode active material layer 110 and positive electrode active material layer 120. Solid electrolyte layer 130 is in contact with each of negative electrode active material layer 110 and positive electrode active material layer 120. Solid electrolyte layer 130 is a layer containing an electrolyte material. As the electrolyte material, generally known battery electrolytes can be used. The thickness of solid electrolyte layer 130 may be at least 5 μm and at most 300 μm, or may be at least 5 μm and at most 100 μm.

Solid electrolyte layer 130 contains a solid electrolyte as an electrolyte material. Battery 1000 may be, for example, an all-solid-state battery.

As the solid electrolyte, the materials exemplified as the solid electrolyte contained in the negative electrode material mentioned above can be used. It should be noted that in addition to the electrolyte material, solid electrolyte layer 130 may contain, for example, a binding binder such as polyvinylidene fluoride.

In battery cell 2000, negative electrode active material layer 110, positive electrode active material layer 120, and solid electrolyte layer 130 are maintained in the form of parallel plates. Accordingly, it is possible to suppress the occurrence of cracks or collapse due to bending. It should be noted that negative electrode active material layer 110, positive electrode active material layer 120, and solid electrolyte layer 130 may be combined and smoothly curved.

Negative electrode current collector 210 and positive electrode current collector 220 are members having electrical conductivity. Negative electrode current collector 210 and positive electrode current collector 220 may each be, for example, a conductive thin film. As a material that constitutes negative electrode current collector 210 and positive electrode current collector 220, a metal such as stainless steel (SUS), aluminum (Al), copper (Cu), or nickel (Ni) can be used.

Negative electrode current collector 210 is arranged in contact with negative electrode active material layer 110. As negative electrode current collector 210, for example, metal foil such as SUS foil, Cu foil, or Ni foil can be used. The thickness of negative electrode current collector 210 is, for example, at least 5 μm and at most 100 μm, but is not limited thereto. It should be noted that negative electrode current collector 210 may include, for example, a current collector layer containing a conductive material in a portion in contact with negative electrode active material layer 110.

Positive electrode current collector 220 is arranged in contact with positive electrode active material layer 120. As positive electrode current collector 220, for example, metal foil such as SUS foil, Al foil, Cu foil, or Ni foil can be used. The thickness of negative electrode current collector 210 is, for example, at least 5 μm and at most 100 μm, but is not limited thereto. It should be noted that positive electrode current collector 220 may include, for example, a current collector layer that is a layer containing a conductive material in a portion in contact with positive electrode active material layer 120.

The side surface of battery cell 2000 is a cut surface formed by collectively cutting, for example, negative electrode current collector 210, negative electrode active material layer 110, solid electrolyte layer 130, positive electrode current collector 220, and positive electrode active material layer 120 with a cutting blade. The side surface of battery cell 2000 is formed, for example, by collectively cutting battery cell 2000 so that a cut surface along the thickness direction of battery cell 2000 is formed. On the side surface of battery cell 2000, for example, negative electrode current collector 210, negative electrode active material layer 110, solid electrolyte layer 130, positive electrode current collector 220, and positive electrode active material layer 120 are exposed. It should be noted that not all the layers and current collectors included in battery cell 2000 may be exposed on the side surface of battery cell 2000.

The side surface of battery cell 2000 is provided with striated cut marks 800, which are examples of striated recesses or striated protrusions. Striated cut marks 800 result from the collective cutting mentioned above. Striated cut mark 800 is a striated fine recess or protrusion on the side surface caused by the cuttability when the cutting blade and battery cell 2000 are brought into contact with each other, the stress distribution, the non-uniformity of micro collapse of the material of each layer, and the like. Striated cut marks 800 are, for example, linear. Striated cut marks 800 are provided, for example, on the side surfaces of battery cell 2000 so as to connect negative electrode active material layer 110 and positive electrode active material layer 120. Striated cut marks 800 may be provided on the side surface of battery cell 2000 so as to connect negative electrode current collector 210 and positive electrode current collector 220. Striated cut marks 800 provided on the side surface of battery cell 2000 are inclined with respect to the thickness direction of battery cell 2000 in a plan view of the side surface, and the thickness direction of battery cell 2000 and the striated cut mark are inclined. 800 has significant non-zero angle difference θ. The thickness direction of battery cell 2000 in a plan view of the side surface of battery cell 2000 is the direction indicated by arrow Z, in other words, the short direction of each layer in a plan view of the side surface of battery cell 2000. In addition, the thickness direction of battery cell 2000 in a plan view of the side surface of battery cell 2000 is also the direction in which negative electrode active material layer 110, solid electrolyte layer 130, and positive electrode active material layer 120 are aligned in a plan view of the side surface. In addition, angle difference θ is the angle formed by striated cut mark 800 and the thickness direction of battery cell 2000 in a plan view of the side surface of battery cell 2000.

A plurality of striated cut marks 800 are provided on the side surface of battery cell 2000, and the plurality of striated cut marks 800 are parallel to each other. That is, the distance between adjacent striated cut marks 800 is the same at any position. In addition, striated cut marks 800 that are recesses and striated cut marks 800 that are protrusions may be mixed in the plurality of striated cut marks 800.

Although the details will be described later, when cutting battery cell 2000 with a cutting blade, striated cut marks 800 are formed by cutting battery cell 2000 so that the direction of relative movement of the cutting blade with respect to battery cell 2000 is inclined with respect to the thickness direction of battery cell 2000.

Here, the effect of battery 1000 will be described with reference to battery 1000X in Comparative Example. FIG. 2 is a schematic side view showing a schematic configuration of battery 1000X in Comparative Example. FIG. 2 is a diagram in a plan view of the side surface of battery 1000X.

As shown in FIG. 2, the side surface of battery cell 2000 included in battery 1000X is provided with striated cut marks 800X that are not inclined with respect to the thickness direction of battery cell 2000 in a plan view of the side surface of battery cell 2000.

As mentioned above, the electric field tends to concentrate on the striated recesses or protrusions provided on the side surface, and the striated recesses or protrusions tend to be the start and end of the edge surface discharge on the side surface. in a plan view of the side surface of battery cell 2000, since striated cut marks 800X are not inclined with respect to the thickness direction of battery cell 2000, striated cut marks 800X are provided so as to connect negative electrode current collector 210 or negative electrode active material layer 110 and positive electrode current collector 220 or positive electrode active material layer 120 at the shortest distance. For that reason, the edge surface discharge along striated cut mark 800X is likely to occur.

On the other hand, in battery 1000 according to the present embodiment shown in FIG. 1, striated cut marks 800 are inclined with respect to the thickness direction of battery cell 2000 in a plan view of the side surface of battery cell 2000. For that reason, compared with striated cut marks 800X in Comparative Example, striated cut marks 800 between negative electrode current collector 210 or negative electrode active material layer 110 and positive electrode current collector 220 or positive electrode active material layer 120 become longer. That is, of striated cut marks 800 on which an electric field tends to concentrate, the distance between the portion provided on negative electrode current collector 210 or negative electrode active material layer 110 and the portion provided on positive electrode current collector 220 or positive electrode active material layer 120 becomes longer. Therefore, by suppressing the occurrence of edge surface discharge on the side surface of battery cell 2000, the occurrence of a short circuit due to dielectric breakdown can be suppressed, and highly reliable battery 1000 can be realized.

Angle difference θ is, for example, at least 18 degrees and at most 84 degrees, and may be at least 25 degrees and at most 78 degrees.

Since angle difference θ is at least 18 degrees, the distance between the portion of striated cut marks 800 provided on negative electrode current collector 210 or negative electrode active material layer 110 and the portion provided on positive electrode current collector 220 or positive electrode active material layer 120 of striated cut marks 800 is increased by 5% or more compared to when there is no angle difference θ. As a result, the risk of dielectric breakdown due to edge surface discharge along the side surface of battery cell 2000 can be further reduced. In addition, since angle difference θ is at least degrees, the distance between the portion of striated cut marks 800 provided on negative electrode current collector 210 or negative electrode active material layer 110 and the portion provided on positive electrode current collector 220 or positive electrode active material layer 120 of striated cut marks 800 is increased by 10% or more compared to when there is no angle difference θ. As a result, the risk of dielectric breakdown due to edge surface discharge along the side surface of battery cell 2000 can be even further reduced.

In addition, since angle difference θ is at most 84 degrees, for example, like the manufacturing method described later, when striated cut marks 800 are formed by cutting down battery cell 2000 while the cutting blade or battery cell 2000 is slid in a direction perpendicular to the thickness direction of battery cell 2000, the slide stroke of battery cell 2000 or the cutting blade is at most 10 times the minimum stroke of the cutting blade required to cut battery cell 2000 (that is, the stroke in the cutting down direction). For that reason, the equipment for cutting battery cell 2000 can be made compact. In addition, since angle difference θ is at most 78 degrees, the slide stroke described above is five times or less the minimum stroke described above. For that reason, the equipment for cutting battery cell 2000 can be made more compact.

The depth of the recess or the height of the protrusion in striated cut mark 800 is, for example, 0.1 μm or more. Even when the concentration of the electric field on striated cut marks 800 is likely to occur, due to the effect that striated cut marks 800 are inclined with respect to the thickness direction of battery cell 2000 as in the present embodiment, the edge surface discharge can be suppressed. In addition, from the viewpoint of suppressing edge surface discharge and suppressing damage originating from striated cut marks 800, the depth of the recesses or the height of the protrusions in striated cut marks 800 is, for example, at most 100 μm, and may be at most 10 μm. It should be noted that when a plurality of striated cut marks 800 are provided, for example, the depth of the deepest recess or the height of the highest protrusion in the plurality of striated cut marks 800 is at least 0.1 μm and at most 100 μm, or at least 0.1 μm and at most 10 μm.

### [Manufacturing Method]

Next, a method for manufacturing battery 1000 will be described.

The method for manufacturing battery 1000 includes, for example, a stacking step and a cutting step.

In the stacking step, battery cell 2000 including, for example, negative electrode current collector 210, negative electrode active material layer 110, solid electrolyte layer 130, positive electrode active material layer 120, and positive electrode current collector 220 is formed. In the stacking step, battery cell 2000 is formed by stacking, for example, negative electrode current collector 210, negative electrode active material layer 110, solid electrolyte layer 130, positive electrode active material layer 120, and positive electrode current collector 220 sequentially in this order. Battery cell 2000 is formed, for example, by applying and drying, on the surface of the current collector or each layer, a paste-like paint obtained by kneading the respective materials of negative electrode active material layer 110, positive electrode active material layer 120, and solid electrolyte layer 130 together with a solvent. Battery cell 2000 may be formed by preparing a negative electrode plate in which negative electrode active material layer 110 and solid electrolyte layer 130 are stacked in this order on negative electrode current collector 210, and a positive electrode plate in which positive electrode active material layer 120 and solid electrolyte layer 130 are stacked on positive electrode current collector 220, and bonding the negative electrode plate and the positive electrode plate with solid electrolyte layer 130 interposed therebetween. In the stacking step, forming of each layer and bonding of the negative electrode plate and the positive electrode plate may be performed by pressing for densification and compression bonding. It should be noted that the method for forming battery cell 2000 is not limited to the above example, and can be formed by a known battery manufacturing method.

Next, in the cutting step, battery cell 2000 formed in the stacking step is cut with a cutting blade. At this time, striated cut marks 800 mentioned above are formed on the cut surface formed by cutting battery cell 2000 with the cutting blade. Striated cut marks 800 are formed due to the cuttability when the cutting blade and battery cell 2000 are brought into contact with each other, the stress distribution, the non-uniformity of micro collapse of the material of each layer, and the like. In this way, battery 1000 including battery cell 2000 whose side surface is the cut surface on which striated cut marks 800 are formed is formed.

It should be noted that in the cutting step, instead of preparing battery cell 2000 formed in the stacking step, by obtaining battery cell 2000 having each layer stacked in advance, battery cell 2000 may be prepared and used.

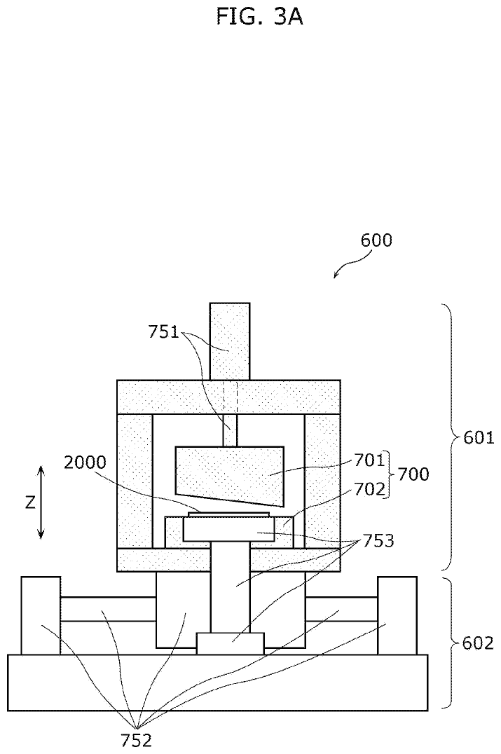

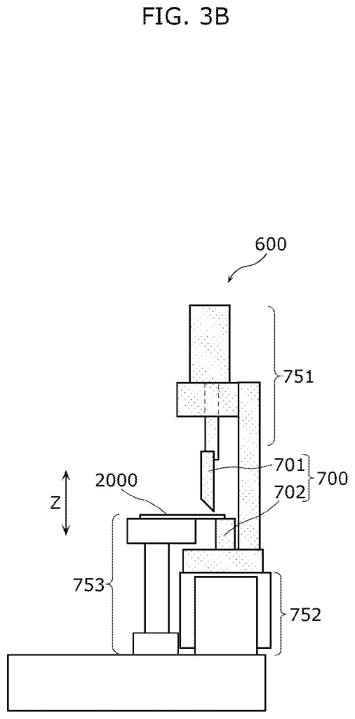

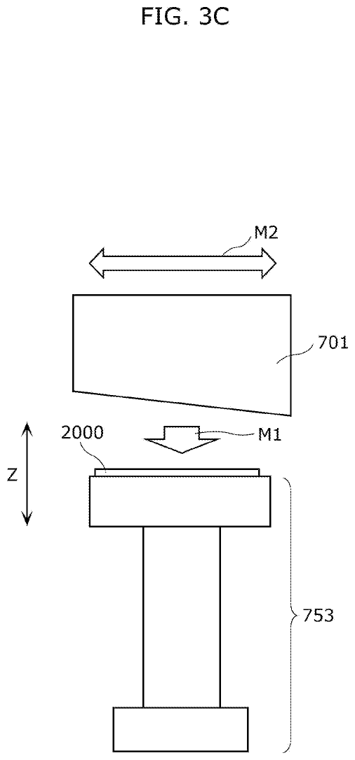

Here, a method for forming striated cut marks 800 that are inclined with respect to the thickness direction of battery cell 2000 in a plan view of the side surface of battery cell 2000 will be described. FIG. 3A is a schematic front view showing an example of cutting device 600 used for cutting battery cells 2000. FIG. 3B is a schematic side view showing an example of cutting device 600 used for cutting battery cell 2000. FIG. 3C is a diagram for explaining an example of movement of cutting device 600. It should be noted that in FIG. 3A and FIG. 3B, cutting unit 601 is patterned with dots, but this is for the sake of visibility, and it is not intended that actual cutting unit 601 is patterned with dots. In addition, in FIG. 3C, for ease of viewing, the illustration of the configuration of cutting device 600 other than movable upper blade 701 and support unit 753 is omitted.

As a method of forming striated cut marks 800 that are inclined with respect to the thickness direction of battery cell 2000, for example, a method using cutting device 600 schematically shown in FIG. 3A and FIG. 3B can be used.

Cutting device 600 includes cutting unit 601, slide unit 602, and support unit 753.

Cutting unit 601 is entirely placed on slide unit 602. Cutting unit 601 is patterned with dots in FIG. 3A and FIG. 3B. Cutting unit 601 includes cutting blade 700 and cutting blade actuator 751.

Cutting blade 700 is composed of movable upper blade 701 and fixed lower blade 702. The lower end of movable upper blade 701 is the blade edge of movable upper blade 701, and the upper end of fixed lower blade 702 is the blade edge of fixed lower blade 702. Movable upper blade 701 is connected to the lower end of cutting blade actuator 751 and can be moved up and down by cutting blade actuator 751. Specifically, the end of movable upper blade 701 opposite to the blade edge is connected to cutting blade actuator 751. Cutting blade actuator 751 is, for example, an air cylinder, an electric cylinder, or the like.

Fixed lower blade 702 is disposed below movable upper blade 701 and at a position where it does not come into contact with movable upper blade 701 when movable upper blade 701 moves up and down so that the object sandwiched between movable upper blade 701 and fixed lower blade 702 can be cut by moving movable upper blade 701 up and down. Accordingly, battery cell 2000 disposed between movable upper blade 701 and fixed lower blade 702 can be cut by being sandwiched between the blade edge of movable upper blade 701 and the blade edge of fixed lower blade 702.

The lower end of movable upper blade 701 is inclined with respect to the upper end of fixed lower blade 702. Accordingly, it is possible to reduce the contact area when battery cell 2000 and the blade edge, which is the lower end of movable upper blade 701, come into contact with each other, and to reduce the cutting resistance. It should be noted that the lower end of movable upper blade 701 may be parallel to the upper end of fixed lower blade 702. In addition, the lower end of movable upper blade 701 may be curved.

Slide unit 602 includes slide actuator 752. Slide actuator 752 is an air cylinder, an electric slider, or the like. Cutting unit 601 is mounted on the slide drive portion of slide actuator 752, and cutting unit 601 is configured to be movable in the direction parallel to the length direction of cutting blade 700 by slide actuator 752. That is, the slide drive portion of slide actuator 752 drives in a direction parallel to the length direction of cutting blade 700. The length direction of cutting blade 700 is a direction in which movable upper blade 701 and fixed lower blade 702 extend, and for example, a direction that is orthogonal to the thickness direction of movable upper blade 701 and that intersects (for example, is orthogonal to) the up-and-down movement direction of movable upper blade 701. In addition, when movable upper blade is a long plate-like shape in which the blade edge is disposed at the end of movable upper blade 701 in the short direction as shown in the figure, the length direction is the longitudinal direction of movable upper blade 701.

Support unit 753 is, for example, a stand for supporting battery cell 2000 disposed in front of or behind cutting unit 601 and slide unit 602. Battery cell 2000 to be cut is held on the upper surface of support unit 753. Battery cell 2000 may be fixed and held on support unit 753 by a jig or the like (not shown). Battery cell 2000 is held such that movable upper blade 701 is positioned above the main surface of battery cell 2000. In addition, part of battery cell 2000 is placed on fixed lower blade 702. Battery cell 2000 is held so that the height of the upper surface of support unit 753 and the height of the upper end of fixed lower blade 702 are the same and that the up-and-down movement direction of movable upper blade 701 and the thickness direction of battery cell 2000 are parallel. For example, battery cell 2000 is held so that the main surface of battery cell 2000 is horizontal. Accordingly, battery cell 2000 is less likely to shift when battery cell 2000 is cut, and cutting accuracy can be improved.

Support unit 753 is not connected to slide actuator 752 and its position is fixed. For that reason, battery cell 2000 held by support unit 753 also does not move when slide actuator 752 is driven.

In cutting blade actuator 751 and slide actuator 752, for example, the mutual position information is linked based on position sensor signals or drive pulse information, and while cutting blade 700 slides in the length direction of cutting blade 700, battery cell 2000 held by support unit 753 is cut. It should be noted that support unit 753 may hold a plurality of stacked battery cells 2000, and the plurality of battery cells 2000 may be cut at once.

Specifically, as shown in FIG. 3C, when cutting battery cell 2000, movable upper blade 701 is moved by cutting blade actuator 751 in the direction indicated by arrow M1. The direction indicated by arrow M1 is parallel to the thickness direction of battery cell 2000, for example. In addition, at the same time, entire cutting unit 601 including movable upper blade 701 is moved by slide actuator 752 in one of the directions indicated by arrow M2. The direction indicated by arrow M2 is the length direction of cutting blade 700. Accordingly, in the cutting step, battery cell 2000 is cut down by movable upper blade 701 of cutting blade 700 from above the main surface of battery cell 2000 while sliding cutting blade 700 in the length direction of cutting blade 700. At this time, the direction of relative movement of movable upper blade 701 of cutting blade 700 with respect to battery cell 2000 in the cutting step is inclined with respect to the thickness direction of battery cell 2000 in a plan view of a cut surface formed when battery cell 2000 is cut by cutting blade 700. As a result, striated cut marks 800 inclined with respect to the thickness direction of battery cell 2000 can be formed on the formed cut surface. It should be noted that cutting down means cutting battery cell 2000 by moving the blade edge of movable upper blade 701 toward battery cell 2000. For that reason, when cutting down, for example, movable upper blade 701 moves vertically downward, but depending on the relative positional relationship between movable upper blade 701 and battery cell 2000, movable upper blade 701 may not necessarily move vertically downward.

The direction of relative movement of movable upper blade 701 with respect to battery cell 2000 is the composite direction of the direction indicated by arrow M1 and the direction indicated by arrow M2. For example, striated cut marks 800 inclined to the direction shown in FIG. 1 are formed by movable upper blade 701 moving in the direction of arrow M1, and at the same time, entire cutting unit 601 sliding leftward in FIG. 3C of the directions indicated by arrow M2. When entire cutting unit 601 does not slide and battery cell 2000 is cut only by movable upper blade 701 moving in the direction of arrow M1, striated cut marks 800X shown in FIG. 2 are formed.

When the lower end of movable upper blade 701 is inclined as shown in FIG. 3C, the stroke of movable upper blade 701 can be reduced by entire cutting unit 601 sliding from the side closer to support unit 753 out of the lower end of movable upper blade 701 to the side farther from support unit 753 out of the lower end of movable upper blade 701, that is, sliding to the left in FIG. 3C among the directions indicated by arrow M2. In addition, the load when cutting battery cell 2000 by movable upper blade 701 can be reduced by entire cutting unit 601 sliding from the side farther from support unit 753 out of the lower end of movable upper blade 701 to the side closer to support unit 753 out of the lower end of movable upper blade 701, that is, sliding to the right in FIG. 3C among the directions indicated by arrow M2.

In addition, when cutting battery cell 2000, the angle difference between the thickness direction of battery cell 2000 and striated cut mark 800 can be changed by the setting of the cutting speed of cutting blade actuator 751 and the setting of the sliding speed of slide actuator 752. The cutting speed is the speed at which movable upper blade 701 cuts down battery cell 2000, and the slide speed is the speed at which cutting blade 700 slides in the longitudinal direction of cutting blade 700. In addition, in setting the speeds of cutting blade actuator 751 and slide actuator 752, it is also possible to make striated cut mark 800 into a curved shape by changing the relationship between the cutting speed and the sliding speed while battery cell 2000 is being cut. For example, by accelerating the cutting speed or the sliding speed at the start of cutting battery cell 2000 or by decelerating the cutting speed or the sliding speed before the end of cutting battery cell 2000, the relationship between the cutting speed and the sliding speed is changed. In addition, the relationship between the cutting speed and the sliding speed may be changed by continuing to accelerate or decelerate the cutting speed or the sliding speed while battery cell 2000 is being cut.

In addition, another advantage of manufacturing by the method in which cutting blade actuator 751 and slide actuator 752 cooperate based on their mutual positional information to produce an angle difference between striated cut mark 800 and the thickness direction of battery cell 2000 is a reduction in cutting load, which can improve the reliability of battery 1000.

Specifically, in the cutting step, battery cell 2000 is cut down by movable upper blade 701 of cutting blade 700 while sliding cutting blade 700 in the length direction of cutting blade 700. Therefore, not only battery cell 2000 is pushed through, but also the blade edge of movable upper blade 701 is slid to cut battery cell 2000, so that the cutting resistance can be reduced. Accordingly, since the stress applied to battery cell 2000 during cutting is reduced, the risk of damage such as microcracks occurring inside battery cell 2000 near the cut surface due to the stress can be reduced, so that the reliability of battery 1000 can be improved.

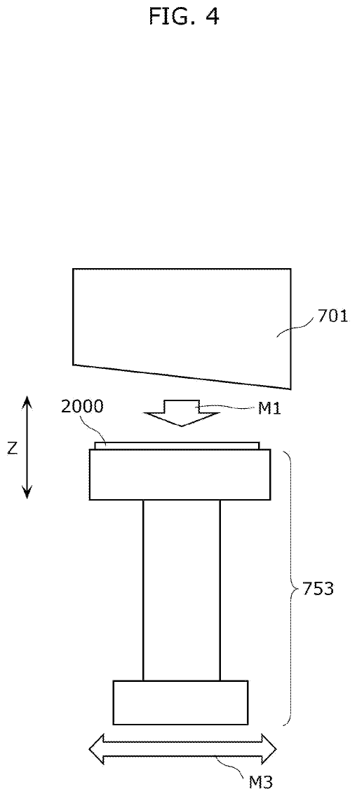

It should be noted that in the method for cutting battery cell 2000 described above, cutting blade 700 is slid in the length direction of cutting blade 700, but the method is not limited thereto. In the cutting step, battery cell 2000 may be cut down by movable upper blade 701 of cutting blade 700 while sliding battery cell 2000 in the length direction of cutting blade 700. FIG. 4 is a diagram for explaining another example of the movement of cutting device 600. In cutting device 600 shown in FIG. 3A and FIG. 3B, cutting unit 601 is slid and support unit 753 is fixed, but FIG. 4 shows the case where cutting unit 601 is fixed and support unit 753 is slid. That is, support unit 753 may be connected to slide actuator 752 and driven by slide actuator 752.

As shown in FIG. 4, when cutting battery cell 2000, movable upper blade 701 is moved by cutting blade actuator 751 in the direction indicated by arrow M1. In addition, at the same time, support unit 753 is moved by slide actuator 752 in one of the directions indicated by arrow M3. The direction indicated by arrow M3 is the length direction of cutting blade 700. Accordingly, in the cutting step, while battery cell 2000 held by support unit 753 is slid in the length direction of cutting blade 700, battery cell 2000 is cut down by movable upper blade 701 of cutting blade 700 from above the main surface of battery cell 2000. As a result, striated cut marks 800 inclined with respect to the thickness direction of battery cell 2000 can be formed on the formed cut surface. For example, movable upper blade 701 moves in the direction of arrow M1, and at the same time, battery cell 2000 held by support unit 753 slides in the right direction in FIG. 4 in the direction indicated by arrow M3, thereby forming striated cut marks 800 inclined in the direction shown in FIG. 1. Such a method can also reduce the cutting resistance when cutting battery cell 2000. In addition, in this case, the slide speed is the speed at which battery cell 2000 is slid in the length direction of cutting blade 700.

In addition, in the cutting step, battery cell 2000 may be held so that the main surface of battery cell 2000 is inclined with respect to the length direction of cutting blade 700. In this case, since the thickness direction of battery cell 2000 is inclined with respect to the movement direction of movable upper blade 701, the relative movement direction of movable upper blade 701 of cutting blade 700 with respect to battery cell 2000 is inclined with respect to the thickness direction of battery cell 2000 in a plan view of the cut surface formed when battery cell 2000 is cut by a cutting blade. Therefore, without using slide actuator 752, only by cutting down battery cell 200 with movable upper blade 701 of cutting blade 700, striated cut marks 800 inclined with respect to the thickness direction of battery cell 2000 can be formed.

### VARIATIONS

Next, a variation of Embodiment 1 will be described. In the following description of the variation, differences from Embodiment 1 will be mainly described, and descriptions of common points will be omitted or simplified.

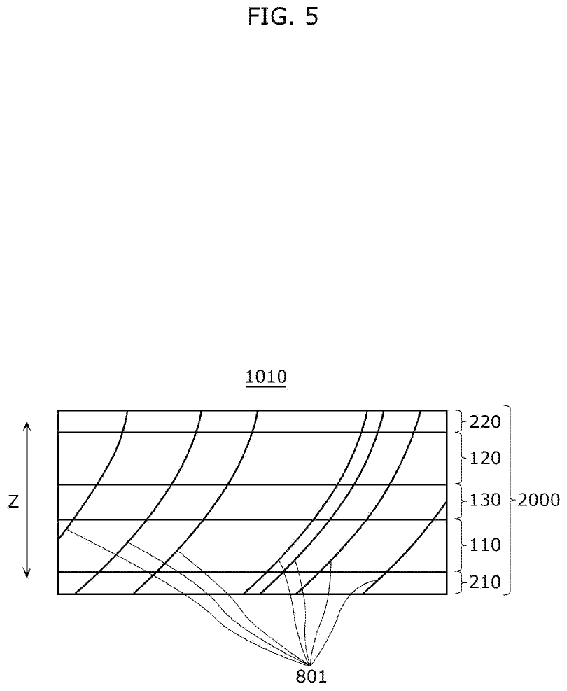

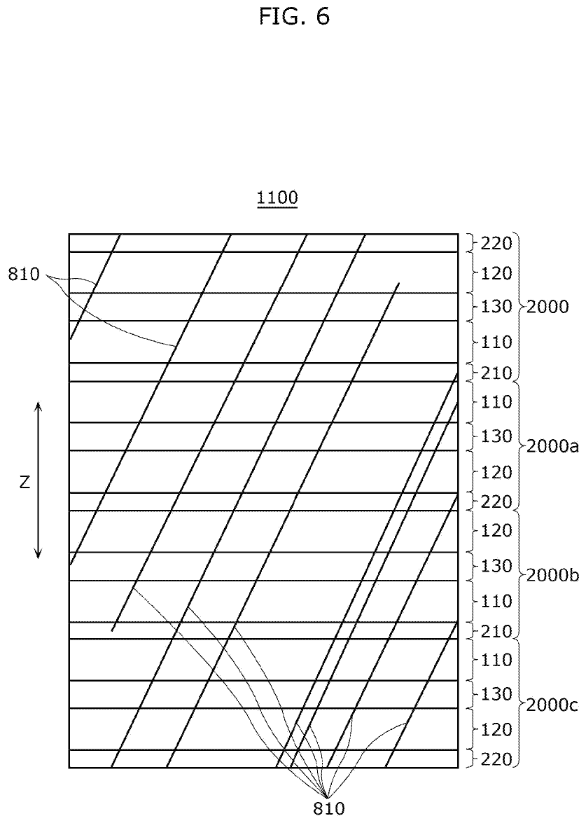

FIG. 5 is a side view showing a schematic configuration of battery 1010 in a variation of Embodiment 1. FIG. 5 is a diagram in a plan view of the side surface of battery 1010. In addition, FIG. 5 is also a diagram in a plan view of the side surface of battery cell 2000 provided in battery 1010.

As shown in FIG. 5, battery 1010 according to the variation of Embodiment 1 is different from battery 1000 according to Embodiment 1 in that the side surface of battery cell 2000 is provided with striated cut marks 801 instead of striated cut marks 800.

In battery 1010 as well, the side surface of battery cell 2000 is a cut surface by collective cutting, and the side surface of battery cell 2000 is provided with striated cut marks 801, which are examples of striated recesses or protrusions. In a plan view of the side surface of battery cell 2000, striated cut marks 801 are curved. In the example shown in FIG. 5, striated cut mark 801 is curved as a whole, but may include a straight portion and a curved portion. In addition, at least a part of striated cut marks 801 is inclined with respect to the thickness direction of battery cell 2000 in a plan view of the side surface of battery cell 2000. In the example shown in FIG. 5, striated cut marks 801 are inclined with respect to the thickness direction of battery cell 2000 at all portions.

In the example shown in FIG. 5, striated cut mark 801 is curved so that the lower side is convex, but it may be curved so that the upper side is convex. In addition, striated cut mark 801 may include a portion that is curved so that the lower side is convex and a portion that is curved so that the upper side is convex.

In a plan view of the side surface of battery cell 2000, the angle formed by the straight line connecting both ends of striated cut mark 801 and the thickness direction of battery cell 2000 is, for example, at least 18 degrees and at most 84 degrees, and may be at least 25 degrees and at most 78 degrees.

In battery 1010, since striated cut marks 801 are curved, striated cut mark 801 between negative electrode current collector 210 or negative electrode active material layer 110 and positive electrode current collector 220 or positive electrode active material layer 120 becomes longer compared with the case where striated cut mark 801 is not curved. That is, the distance between a part provided on negative electrode current collector 210 or negative electrode active material layer 110 and a part provided on positive electrode current collector 220 or positive electrode active material layer 120, where the electric field tends to concentrate, among striated cut marks 801 becomes longer. Therefore, by suppressing the occurrence of edge surface discharge on the side surface of battery cell 2000, the occurrence of a short circuit can be suppressed, and battery 1010 with higher reliability can be realized.

Striated cut mark 801 is formed by, for example, changing the relationship between the cutting speed and the sliding speed during cutting of battery cell 2000 in the speed setting of cutting blade actuator 751 and slide actuator 752 in the cutting step described above. That is, the relative moving direction of movable upper blade 701 of cutting blade 700 with respect to battery cell 2000 in the cutting step changes during the cutting of battery cell 2000.

### Embodiment 2

Next, Embodiment 2 will be described. In the following description of Embodiment 2, differences from Embodiment 1 will be mainly described, and descriptions of common points will be omitted or simplified. The battery according to Embodiment 2 is a stacked battery in which a plurality of battery cells are stacked.

FIG. 6 is a schematic side view showing the schematic configuration of battery 1100 according to Embodiment 2. FIG. 6 is a diagram in a plan view of the side surface of battery 1100. In addition, FIG. 6 is also a diagram in a plan view of the side surfaces of the plurality of battery cells 2000, 2000a, 2000b, and 2000c provided in battery 1100 on the same side.

As shown in FIG. 6, battery 1100 according to Embodiment 2 includes a plurality of battery cells 2000, 2000a, 2000b, and 2000c including battery cell 2000 provided in battery 1000 according to Embodiment 1. The plurality of battery cells 2000, 2000a, 2000b, and 2000c are stacked.

Battery 1100 has a structure in which the plurality of battery cells 2000, 2000a, 2000b, and 2000c are electrically connected in parallel and stacked. Battery 1100 is a parallel-stacked battery in which the plurality of battery cells 2000, 2000a, 2000b, and 2000c are integrated by adhesion, bonding, or the like. Specifically, adjacent battery cells in the plurality of battery cells 2000, 2000a, 2000b, and 2000c are stacked such that the stacked order of each layer is reversed. Negative electrode current collectors 210 and positive electrode current collectors 220 in the plurality of battery cells 2000, 2000a, 2000b, and 2000c are electrically connected to each other by leads or the like (not shown), so that the plurality of battery cells 2000, 2000a, 2000b and 2000c are connected in parallel. A lead or the like connecting the collectors to each other is connected to, for example, an extraction electrode.

Each of the plurality of battery cells 2000, 2000a, 2000b, and 2000c includes negative electrode active material layer 110, solid electrolyte layer 130, and positive electrode active material layer 120, and may further include one of negative electrode current collector 210 or positive electrode current collector 220. Specifically, battery cell 2000 includes negative electrode current collector 210, negative electrode active material layer 110, solid electrolyte layer 130, positive electrode active material layer 120, and positive electrode current collector 220. In addition, each of battery cell 2000a and battery cell 2000c includes negative electrode active material layer 110, solid electrolyte layer 130, positive electrode active material layer 120, and positive electrode current collector 220. In addition, battery cell 2000b includes negative electrode current collector 210, negative electrode active material layer 110, solid electrolyte layer 130, and positive electrode active material layer 120. In each of battery cells 2000a, 2000b, and 2000c, negative electrode current collector 210 or positive electrode current collector 220 and negative electrode active material layer 110 or positive electrode active material layer 120 of the adjacent battery cell are in contact with each other, and share a current collector. It should be noted that the plurality of battery cells 2000, 2000a, 2000b, and 2000c may not share a current collector, and all battery cells may include negative electrode current collector 210, negative electrode active material layer 110, solid electrolyte layer 130, positive electrode active material layer 120, and positive electrode current collector 220.

Various methods, such as end face terminals, upper and lower end terminals, or current collecting tabs, can be used for extracting the electrodes from battery 1100.

On the side surfaces of the plurality of battery cells 2000, 2000a, 2000b, and 2000c in battery 1100, striated cut marks 810, which are striated recesses or protrusions resulting from the above-mentioned cutting step for cutting the plurality of battery cells 2000, 2000a, 2000b, and 2000c, are provided. In a plan view of the side surfaces of the plurality of battery cells 2000, 2000a, 2000b, and 2000c, striated cut marks 810 are inclined with respect to the thickness direction of the plurality of battery cells 2000, 2000a, 2000b, and 2000c. Each side surface of the plurality of battery cells 2000, 2000a, 2000b, and 2000c are a cut surface formed by the cutting step mentioned above. Among the plurality of battery cells 2000, 2000a, 2000b, and 2000c, striated cut marks 810 in adjacent battery cells are continuous and have a linear shape. Striated cut marks 810 are provided over the side surfaces of adjacent battery cells among the plurality of battery cells 2000, 2000a, 2000b, and 2000c. In the example shown in FIG. 6, there is also striated cut mark 810 that is continuous across all the side surfaces of the plurality of battery cells 2000, 2000a, 2000b, and 2000c. Striated cut marks 810 may not extend to the edges of battery 1100, and may be discontinued on the side surfaces of the plurality of battery cells 2000, 2000a, 2000b, and 2000c.

Striated cut marks 810 are formed by collectively cutting the stacked battery cells 2000, 2000a, 2000b, and 2000c in a cutting step. Therefore, the manufacturing process of battery 1100 can be simplified.

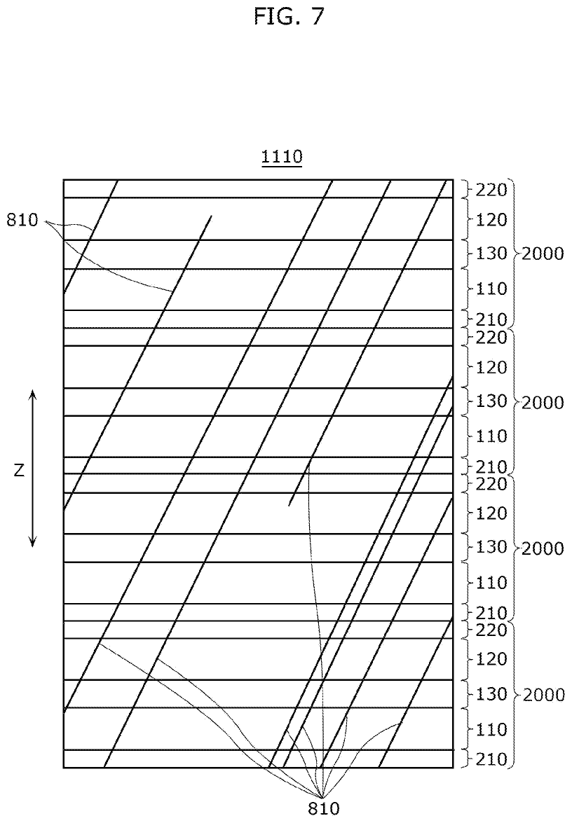

In addition, a stacked battery such as battery 1100 is not limited to a parallel-stacked battery, and may be a serially-stacked battery. FIG. 7 is a schematic side view showing a schematic configuration of another battery 1110 according to Embodiment 2. Battery 1110 includes a plurality of battery cells 2000. Battery 1110 has a structure in which a plurality of battery cells 2000 are electrically connected in series and stacked. Battery 1110 is a serially-stacked battery in which a plurality of battery cells 2000 are integrated by adhesion, bonding, or the like. Specifically, each of the plurality of battery cells 2000 is stacked such that the layers are stacked in the same order. Accordingly, the plurality of battery cells 2000 are electrically connected in series. For example, an extraction electrode is connected to each of negative electrode current collector 210 and positive electrode current collector 220 that are included in the main surface of battery 1110.

In battery 1110 as well, similarly to battery 1100, in a plan view of the side surfaces of the plurality of battery cells 2000, striated cut marks 810, which are inclined with respect to the thickness direction of the plurality of battery cells 2000, are provided on the side surface of each of the plurality of battery cells 2000.

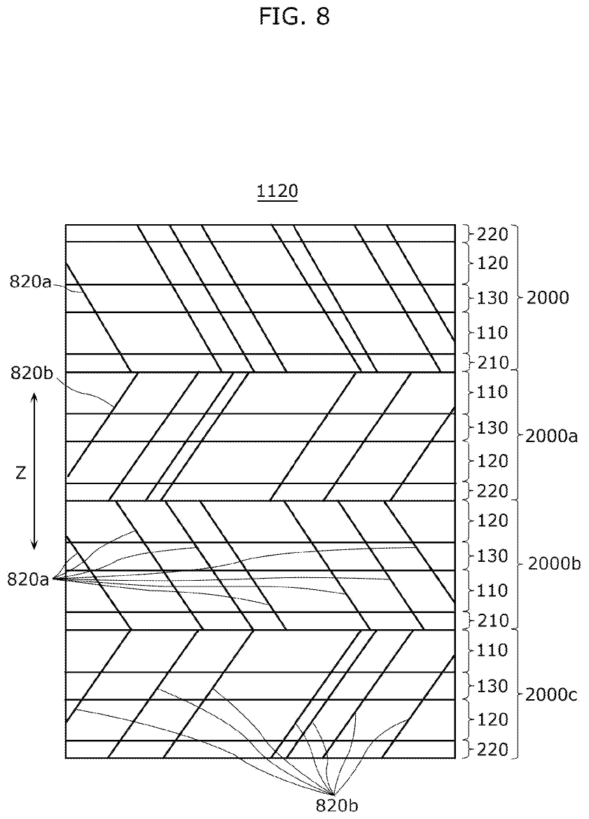

In addition, the striated cut marks provided on the stacked battery may not be continuous in adjacent battery cells. A striated cut mark formed by collectively cutting one or some of the plurality of battery cells may be provided. FIG. 8 is a schematic side view showing a schematic configuration of still another battery 1120 according to Embodiment 2. Battery 1120 is a parallel-stacked battery in which a plurality of battery cells 2000, 2000a, 2000b, and 2000c are stacked in the same manner as battery 1100. Battery 1120 is provided with striated cut marks 820a and striated cut marks 820b instead of striated cut marks 810 in battery 1100.

Among the plurality of battery cells 2000, 2000a, 2000b, and 2000c, one of the adjacent battery cells is provided with striated cut marks 820a on the side surface, and the other battery cell is provided with striated cut marks 820b on the side surface. Striated cut marks 820a and striated cut marks 820b are not continuous. In a plan view of the side surfaces of the plurality of battery cells 2000, 2000a, 2000b, and 2000c, striated cut marks 820a and striated cut marks 820b are inclined in opposite directions with respect to the thickness direction of the plurality of battery cells 2000, 2000a, 2000b, and 2000c. For example, in the plane of paper of FIG. 8, striated cut marks 820a provided on battery cell 2000b are inclined downward to the right, and striated cut marks 820b provided on battery cell 2000c are inclined downward to the left, which is the opposite direction of downward to the right. In this way, in battery 1120, the plurality of battery cells 2000, 2000a, 2000b, and 2000c are stacked such that striated cut marks 820a and striated cut marks 820b alternate on each side surface of the plurality of battery cells 2000, 2000a, 2000b, and 2000c. That is, on the side surfaces of the plurality of battery cells 2000, 2000a, 2000b, and 2000c, striated cut marks 820a and striated cut marks 820b are zigzag. Accordingly, even when battery 1120 is subjected to an impact or the like, damage to battery 1120 originating from striated cut marks 820a and striated cut marks 820b is less likely to propagate, and the reliability of battery 1120 can be improved.

In battery 1120, in the cutting step, a plurality of battery cells 2000, 2000a, 2000b, and 2000c are individually and collectively cut to form cut surfaces. Battery 1120 is formed by stacking a plurality of individually cut battery cells 2000, 2000a, 2000b, and 2000c. At this time, for example, battery cell 2000 and battery cell 2000b are cut so as to form striated cut marks 820a, and battery cell 2000a and battery cell 2000c are cut so as to form striated cut marks 820b.

### OTHER EMBODIMENTS

Although the battery according to the present disclosure has been described above based on the embodiments and variations, the present disclosure is not limited to these embodiments and variations. Forms obtained by applying various modifications to embodiments and variations conceived by a person skilled in the art and other forms constructed by combining some components in the embodiments and variations without departing from the spirit of the present disclosure are also included in this disclosure.

In addition, the above embodiments and variations can be modified, replaced, added, omitted, or the like in various ways within the scope of claims or equivalents thereof.

### INDUSTRIAL APPLICABILITY

A battery according to the present disclosure can be used as a battery for electronic equipment, electric appliance devices, electric vehicles, and the like.

1. A battery comprising:
at least one battery cell,
wherein the at least one battery cell includes a positive electrode layer, a negative electrode layer, and a solid electrolyte layer disposed between the positive electrode layer and the negative electrode layer, and
in a plan view of a side surface of the at least one battery cell, the side surface of the at least one battery cell is provided with striated recesses or striated protrusions that are inclined with respect to a thickness direction of the at least one battery cell.

2. The battery according to claim 1,
wherein in a plan view of the side surface of the at least one battery cell, an angle formed between the striated recess or the striated protrusion and the thickness direction is at least 18 degrees and at most 84 degrees.

3. The battery according to claim 1,
wherein in a plan view of the side surface of the at least one battery cell, an angle formed between the striated recesses or the striated protrusions and the thickness direction is at least degrees and at most 78 degrees.

4. The battery according to claim 1,
wherein in a plan view of the side surface of the at least one battery cell, the striated recesses or the striated protrusions are curved.

5. The battery according to claim 1,
wherein a depth of the striated recesses or a height of the striated protrusions is 0.1 μm or more.

6. The battery according to claim 1,
wherein the at least one battery cell comprises a plurality of battery cells, and
the plurality of battery cells are stacked.

7. The battery according to claim 6,
wherein striated recesses or striated protrusions in adjacent battery cells among the plurality of battery cells are continuous.

8. The battery according to claim 6,
wherein in a plan view of side surfaces of adjacent battery cells among the plurality of battery cells, a direction of inclination of the striated recesses or the striated protrusions in one of the adjacent battery cells is opposite a direction of inclination of the striated recesses or the striated protrusions in an other of the adjacent battery cells with respect to the thickness direction.

9. A method for manufacturing a battery including a battery cell including a positive electrode layer, a negative electrode layer, and a solid electrolyte layer disposed between the positive electrode layer and the negative electrode layer, the method comprising:
cutting the battery cell with a cutting blade,
wherein in the cutting, the battery cell is cut down by the cutting blade while at least one of the battery cell or the cutting blade is slid in a length direction of the cutting blade.
